(19) United States
(12) Patent Application Publication
(10) Pub. No.: US 2007/0088867 A1
(43) Pub. Date: Apr. 19, 2007

(54) Memory controller and data processing system with the same

(76) Inventors: Hyun-Duk Cho, Yongin-si (KR); Tae-Gyun Kim, Seongnam-si (KR); Young-Joon Choi, Seongnam-si (KR)

Correspondence Address: VOLENTINE FRANCOS, & WHITT PLLC, ONE FREEDOM SQUARE, 11951 FREEDOM DRIVE SUITE 1260, RESTON, VA, 20190, US

(21) Appl. No.: 11/517,476

(22) Filed: Sep. 8, 2006

(30) Foreign Application Priority Data
Sep. 21, 2005 (KR) 2005-87794

(51) Int. Cl. G06F 13/28

(52) U.S. Cl. 710/22

(57) ABSTRACT

In one aspect, a data processing system includes a OneNAND flash memory which includes an internal non-volatile memory and an internal buffer memory which temporarily stores a page data derived from the internal non-volatile memory, and a first memory controller which includes a speed-up buffer. The memory controller controls read operations of the OneNAND flash memory such that the page data stored in the OneNAND internal buffer memory is sequentially and continuously output in multiple data units from the OneNAND flash memory to an exterior device through the speed-up buffer.

### BACKGROUND OF THE DISCLOSURE

1. Field of the Disclosure

The present disclosure generally relates to memory systems, and more particularly, the present disclosure relates to data processing systems which included a memory and memory controller.

2. Description of the Related Art

Much of the semiconductor market is focused on the implementation of “system on a chip” devices in which a variety of functional blocks are integrated onto a single chip. One example of a system on a chip is a “fusion memory”. A fusion memory is a device having a variety of memory types (e.g., Flash, ROM and RAM), as well as a variety of separate logic blocks, such as a timer and/or specialized communication ports. In addition to a mix of memory and logic, a relatively recent generation of fusion memory is also characterized by being adaptable to a variety of system specifications. One such adaptive fusion memory is referred to as a “OneNAND flash memory”—an example of which is disclosed in a databook titled “NAND FLASH MEMORY & SMARTMEDIA”, published on September, 2003, pp. 635-652.

FIG. 1 is a block diagram schematically illustrating a conventional data processing system, such as that found in a mobile phone, having a OneNAND flash memory. Referring to FIG. 1, the conventional data processing system includes a central processing unit (CPU) 10, a direct memory access (DMA) 20, a first memory controller 30, a second memory controller 40, a DRAM 50 (used as a working memory for the CPU 10), and a OneNAND flash memory 60. The DRAM 50 and the OneNAND flash memory 60 are controlled by the first memory controller 30 and the second memory controller 40, respectively.

During operation, situations arise where data or programming required by the CPU 10 does not currently exist in the DRAM 50. In such instances, the CPU 10 transmits a command and address to the second memory controller 40, which in turn provides the inputted command and address to the OneNAND flash memory 60 using a specialized interface protocol.

Thereafter, the OneNAND flash memory 60 automatically performs a series of data transfer operations to the DRAM 50. These operations include reading a page/block of data from a memory core 61 located within the OneNAND flash memory 60 into buffer memory 62 (also located in the OneNAND flash memory 60) where the data is temporarily stored. Subsequently, the page/block of data is then transferred from the buffer memory 62 to the appropriate memory locations of the DRAM 50 to thus allow the CPU 10 to execute operations dependent upon access to the page/block of data.

When data is transferred from the buffer memory 62 to the DRAM 50, the transfer is executed in a word-by-word fashion that is relatively slow when compared to the transfer of data from core memory 61 to the buffer memory 62. FIG. 2 illustrates an example of a data transfer from the buffer memory 62 to the DRAM 50. The transfer is composed of a sequence of separate “host read” and “host write” operations. As illustrated in FIG. 2, a host read operation is executed during a time T1 (typically about 300 ns) such that a 16-bit word of data is transmitted from the buffer memory 66 to a buffer 21 within the DMA 20. Thereafter, a host write operation is executed during a time T2 (of about 45 ns) to transfer the buffered 16-bit word from the DMA buffer memory 21 to the DRAM 50. Accordingly, the total time needed to transfer each word is about time T1+T2 (or about 345 ns). By repeating the host read and host write operations, an entire page/block of data is eventually provided to the DRAM 50. This repetitive process can consume an excessive amount of time. Further, as the CPU 10 may also need to access various pages/blocks of OneNAND data (via the first memory controller 40), the effects of slow data transfers to the DRAM 50 can be further exasperated.

### SUMMARY OF THE DISCLOSURE

According to an aspect of the present disclosure, a data processing system is provided which includes a OneNAND flash memory which includes an internal non-volatile memory and an internal buffer memory which temporarily stores a page data derived from the internal non-volatile memory, and a first memory controller which includes a speed-up buffer and which controls read operations of the OneNAND flash memory such that the page data stored in the OneNAND internal buffer memory is sequentially and continuously output in multiple data units from the OneNAND flash memory to an exterior device through the speed-up buffer.

According to another aspect of the present disclosure, a data processing system is provided which includes a OneNAND flash memory which includes an internal non-volatile memory and an internal buffer memory which temporarily stores a page data derived from the internal non-volatile memory, and a controlling means for controlling read operations of the OneNAND flash memory such that the page data stored in the OneNAND internal buffer memory is sequentially and continuously output in multiple data units from the OneNAND flash memory to an exterior device through the speed-up buffer.

According to yet another aspect of the present disclosure, a method is provided for extracting data from a OneNAND flash memory to a RAM device, wherein the OneNAND flash memory includes an internal non-volatile memory and an internal buffer memory for temporarily storing a page of data derived from the internal non-volatile memory, The method includes controlling memory operations of the OneNAND flash memory such that the page data stored in the buffer memory is sequentially outputted in multiple data units from the OneNAND flash memory to the RAM, wherein the entire page data is output at an average time period per data unit that is less that a combined time for both a read operation of a data unit from the OneNAND flash memory and a write operation of a data unit to the RAM.

### BRIEF DESCRIPTION OF THE DRAWINGS

The above and other aspects and features of the disclosed embodiments will become readily apparent from the detailed description that follows, with reference to the accompanying drawings, in which:

FIG. 1 is a block diagram schematically illustrating a conventional data processing system having a OneNAND flash memory;

FIG. 2 illustrates an example of the transmission of data from a OneNAND flash memory to a DRAM in the data processing system of FIG. 1;

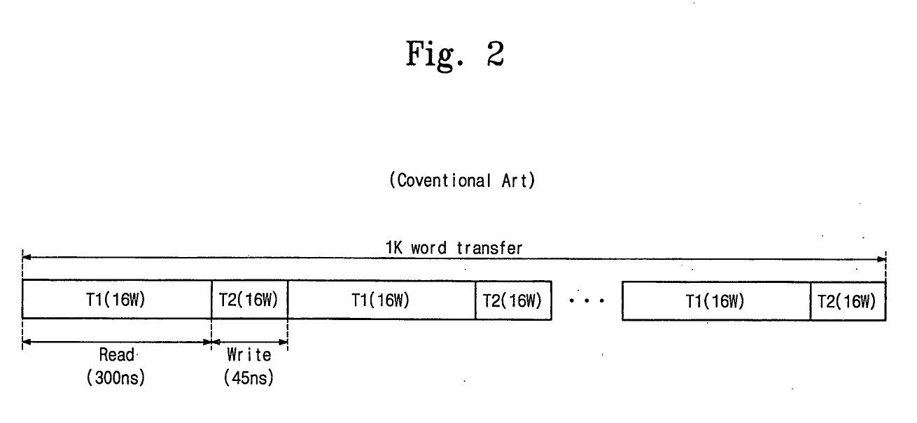

FIG. 3 is a block diagram of a data processing system according to one embodiment of the present disclosure;

FIG. 4 illustrates an example of the transmission of data from a OneNAND flash memory to a DRAM in the data processing system of FIG. 3 according to an embodiment of the present disclosure;

FIG. 5 is a block diagram schematically illustrating the memory controller of FIG. 3 according to an embodiment of the present disclosure; and

FIG. 6 is a block diagram of a data processing system according to another embodiment of the present disclosure.

### DETAILED DESCRIPTION OF EXEMPLARY EMBODIMENTS

It should be understood that both the foregoing general description and the detailed description that follows are merely illustrative, and that the embodiments described herein are non-limiting and presented as examples. As those skilled in the art will appreciate, the methods and systems of the present disclosure may be implemented or applied through other embodiments.

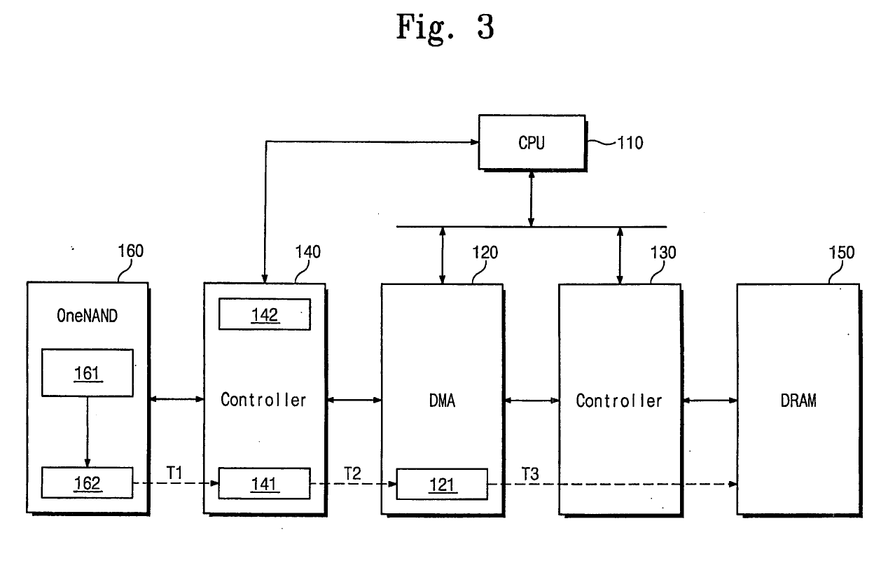

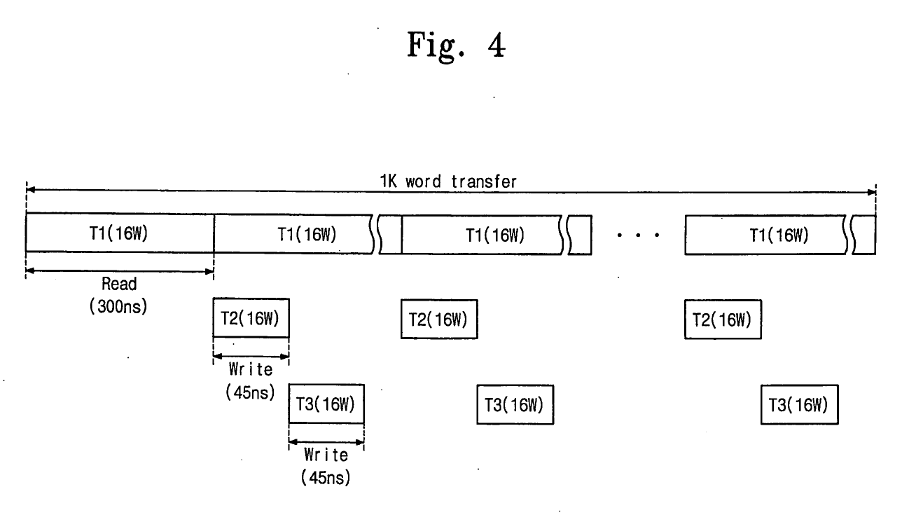

FIG. 3 is a block diagram of a data processing system according to one embodiment of the present disclosure, and FIG. 4 illustrates an example of the transmission of data from a OneNAND flash memory to a DRAM in the data processing system of FIG. 3 according to an embodiment of the present disclosure.

Referring to FIG. 3, the data processing system of this example includes a central processing unit (CPU) 110, a direct memory access (DMA) 120, memory controllers 130 and 140, a DRAM 50, and a OneNAND flash memory 160. The DRAM 150 and the OneNAND flash memory 160 are controlled by the memory controllers 130 and 140, respectively. The memory controller 140 controlls the OneNAND flash memory 160 when access to the OneNAND flash memory 160 is required by either the CPU 10 or the DMA controller 120.

The OneNAND flash memory 160 of this example includes a memory core 161 and a buffer memory 162. Although not illustrated, the OneNAND flash memory 160 may further include a state machine, an error correction code (ECC), a register set, and the like, all of which are known in the field of OneNAND flash memories. The OneNAND buffer memory 162 can be configured such that it performs a dual buffering operation. That is, the OneNAND buffer memory 162 can be configured with two SRAM buffers.

The OneNAND flash memory 160 can also support various known and novel functions. For instance, the OneNAND flash memory 160 may support a single block erase operation, a multi-block erase operation, lock/unlock/lock-tight operations, a copy back operation, a one time programmable (OTP) operation, an access operation to a spare region, a verification read operation, a pipeline read-ahead operation, a block/cash read operation, and so forth. When performing a block read operation, the OneNAND flash memory 160 automatically transmits all the data stored in a particular memory block to the memory controller 140 in response to a command (with address) inputted from the memory controller 140.

Returning to FIG. 3, the memory controller 140 of this example includes “speed-up buffer” 141 and register set 142.

The register set 142 may be used for storing certain pieces of information, such as certain addresses and commands provided by the CPU 110. Using the register set 142, the memory controller 140 communicates with the OneNAND flash memory 160 according to the information stored in the register set 142. For example, should the CPU 110 place a read command in the register set 142, the memory controller 140 responds by outputting the appropriate read command (with respective address) to the OneNAND flash memory 160 according to a predetermined timing and protocol. Note that address data can be in the form of a buffer address, a page address, a block address, etc.

When information relating to the completion of an internal OneNAND memory-core-to-buffer transfer (e.g., a flag) is returned from the OneNAND flash memory 160, the memory controller 140 then takes the buffered data from the OneNAND flash memory 160 in predetermined word sizes. Thereafter, the memory controller 140 temporarily stores the taken data in the speed-up buffer 141, and the memory controller 140 informs the DMA controller 120 that data is stored in the speed-up buffer 141 and available for further transfer to the DMA controller 120.

In a first embodiment, the buffers 141 and 121 of the respective memory controller 140 and the DMA controller 120 can be configured as a first-in first-out (FIFO) memory, but other known or later equivalents, e.g., ping-pong buffers, may alternatively be used.

When data required by the CPU 110 does not exist in the DRAM 150, the CPU 110 transmits the appropriate command and address information to the memory controller 140, where it is stored in register set 142. The memory controller 140 then outputs the address and command information to the OneNAND flash memory 160 according to the appropriate protocol.

As the command and address information is received by the OneNAND flash memory 160, the OneNAND flash memory 160 automatically performs the appropriate internal read operation such that a particular page/block of data is transmitted from the memory core 161 to the OneNAND buffer memory 162 according to the control of a state machine (not shown) embedded within the OneNAND flash memory 160.

Once the internal read operation is completed, the OneNAND flash memory 160 informs the memory controller 140 that the appropriate page/block of data has been entirely transmitted from the memory core 161 to the OneNAND buffer memory 162. Thereafter, the page/block of data stored in the OneNAND buffer memory 162 is sequentially transmitted in predetermined units, e.g., 16-bit word units, to the DRAM in a manner set forth below.

An exemplary operation of transmitting the data from the OneNAND flash memory 160 to the DRAM 150 will now be further described next with reference to FIG. 4.

As illustrated in the example of FIG. 4, a 16-bit data word is read from the OneNAND buffer memory 162 of the OneNAND flash memory 160 to the speed-up buffer 141 of the memory controller 140 during time T1 (e.g., 300 ns). Once the 16-bit data word is stored in the speed-up buffer 141, the 16-bit data word is subsequently written to the buffer memory 121 of the DMA controller 120 during time T2 (e.g., 45 ns) under control of the DMA controller 120. Likewise, once the 16-bit data word is stored in the buffer memory 121 of the DMA controller 120, the 16-bit data word is written to the DRAM 150 for T3 time (e.g., 45 ns) under the control of the memory controller 130.

As can be seen in FIG. 4, various data words can be transmitted from the speed-up buffer 141 to the buffer memory 121 while other data words are simultaneously transmitted from the OneNAND buffer memory 162 to the speed-up buffer 141. Thereafter, the data stored in the OneNAND buffer memory 162 is transmitted to the DRAM 150 through the speed-up buffer 141 and the buffer memory 121 in the same transmission fashion as described above.

In the embodiment describe above, while data is successively transmitted from the OneNAND flash memory 160 to the memory controller 140, data transmission between the speed-up buffer 141 and the buffer memory 121 and between the buffer memory 121 and the DRAM 150 is also performed. As a result, both the time T2 needed for transmitting the data from the speed-up buffer 141 to the buffer memory 121, and the time T3 for transmitting the data from the buffer memory 121 to the DRAM 150 can be overlapped with the data transmission time T1. Thus, the entire page data is output at an average time period per data unit that is less that a combined time for both a read operation of a data unit from the OneNAND flash memory and a write operation of a data unit to the DRAM, and therefore the overall operational transmission speed of the OneNAND flash memory 160 is enhanced.

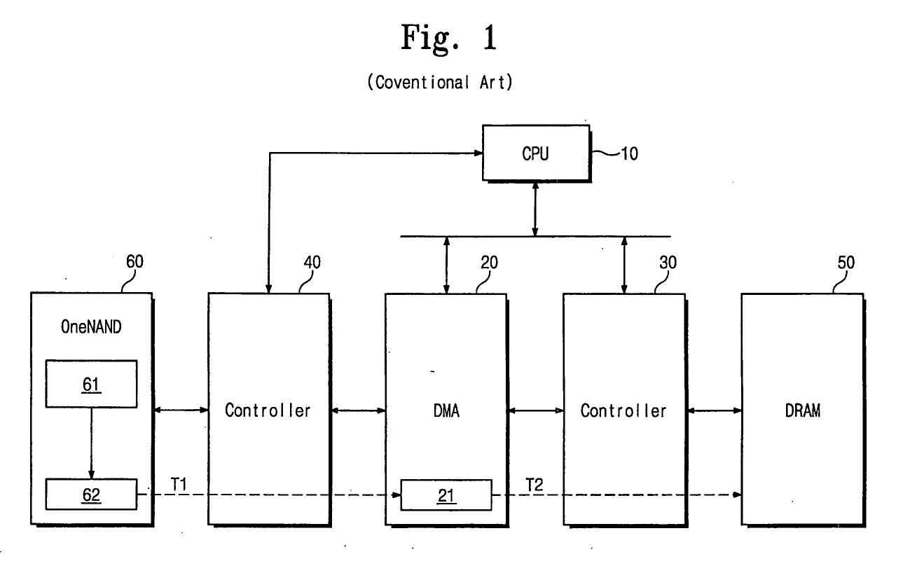

In other words, in contrast to the conventional system of FIG. 1 in which the data units of the page data are sequentially and intermittently transmitted (i.e., a time gap of T2 exist between each sequential T1 read), the present embodiment is characterized in that the page data stored in the OneNAND internal buffer memory is sequentially and continuously output in multiple data units from the OneNAND flash memory to an exterior device through the speed-up buffer (i.e., no time gap or substantially no time gap exists between each sequential T1 read).

For example, when compared to the conventional system of FIG. 1, the transmission times for the exemplary system of FIGS. 3 and 4 is reduced from time period (T1+T2) per word (conventional) to time period T1 per word (exemplary system. This represents a 15% improvement in performance.

The memory controller 140 according to the present disclosure may also minimize the interference of the CPU 110 when the CPU 110 requires an access to the OneNAND flash memory 160. For instance, assuming that the CPU 110 appropriately configures the memory controller's register set 142, the memory controller 140 can appropriately control the read operation for accessing one or more pages of data within the OneNAND flash memory 160. Using the disclosed methods and systems, this accessing of data can be performed at the same time that another page of data is being transmitted to the DRAM 150. Thus, it is possible to reduce the interference caused by the CPU 110 when the CPU 110 provides address information to the register set 142.

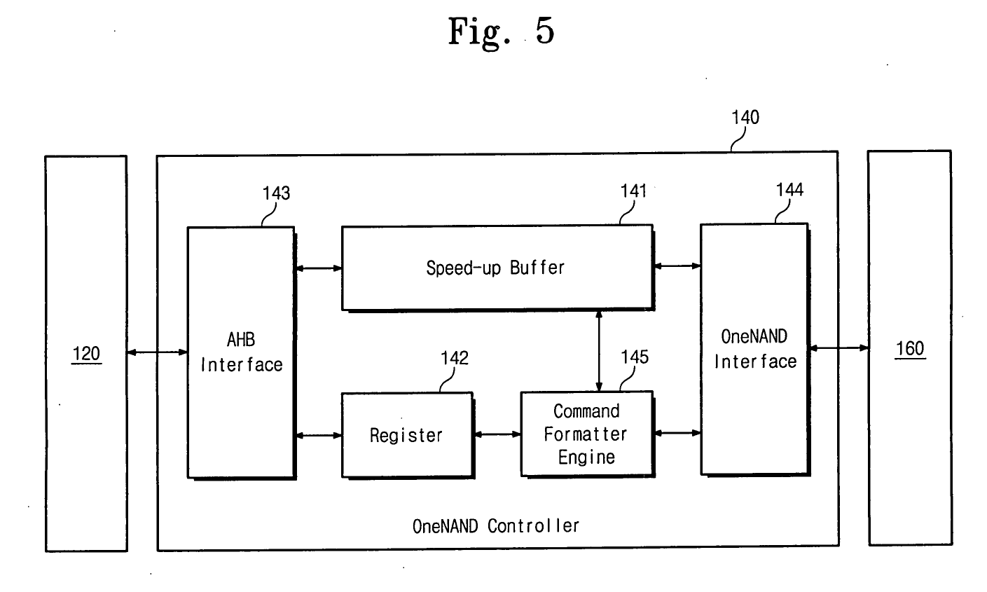

FIG. 5 is a block diagram schematically illustrating an example of the memory controller 140 of FIG. 3. As shown in FIG. 5, the memory controller 140 includes speed-up buffer 141, register set 142, an advanced high-performance bus (AHB) interface block 143, a OneNAND interface block 144, and a command formatter engine 145.

In operation, the speed-up buffer 141, which is controlled by the command formatter engine 145, temporarily stores data that is transmitted from the OneNAND flash memory 160 to the OneNAND interface block 144. The size of the speed-up buffer 141 may be changed from embodiment to embodiment according to where it is applied. The data stored in the speed-up buffer 141 is transmitted to the DMA controller buffer 120 through the AHB interface block 143. The AHB interface block 143 may be used to implement those signals needed for implementing an AHB standard bus protocol used by controllers implementing the advanced microcontroller bus architecture (AMBA) AHB 2.0 lite protocol.

The register set 142, acting as a parameter-storing module, is used for storing addresses, commands, etc. supplied from the DMA controller 120 or the CPU 110.

The command formatter engine 145 formats the command and the data in order to control the OneNAND flash memory 160. The command formatter engine 145 implements a mapping protocol, control access timing, and output commands to the OneNAND flash memory 160.

As described above, in order to minimize interference caused by the CPU 110 when access to the OneNAND flash memory 160 is required, the CPU 110 can provide the address information of the required pages/blocks in the memory controller's register set 142. Subsequently, the command formatter engine 145 can appropriately control the read operations for a next page/block of data while a current page/block of data is being transmitted to the DRAM 150. This may be accomplished by counting the data words loaded in the speed-up buffer 141.

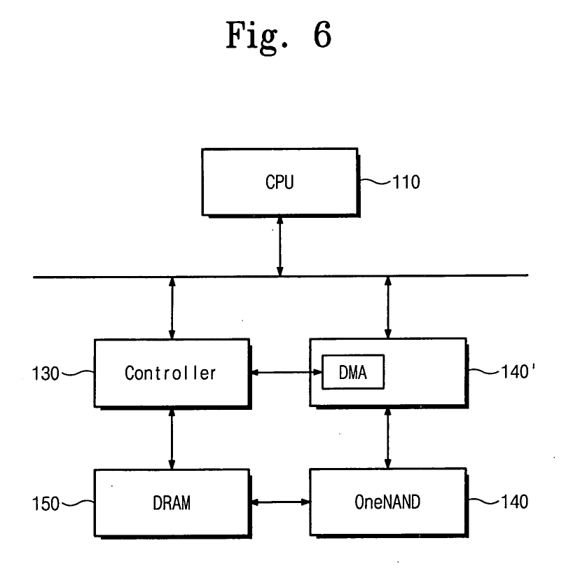

FIG. 6 is a block diagram of a data processing system according to another embodiment of the present disclosure. The data processing system of FIG. 6 is substantially identical to that of FIG. 3 except that the memory controller 140 and DMA controller 120 of FIG. 3 are physically combined as a single memory/DMA controller 140′. Assuming that the memory/DMA controller 140′ is functionally identical to the separate memory controller 140 and DMA controller 120 of FIG. 3, an overall operation can proceed in an identical fashion as described above.

As described above, since both the time T2 (needed for transmitting the data from the speed-up buffer 141 to the buffer memory 121) and the time T3 (needed for transmitting the data from the buffer memory 121 to the DRAM 150) can be made to overlap the data transmission time T1, it is possible to enhance performance of the OneNAND flash memory. In addition, for reasons expressed above it is possible to again lessen interference caused by the CPU 110.

It will be apparent to those skilled in the art that various modifications and variations can be made in the present disclosure. Thus, it is intended that the present disclosure covers the modifications and variations of this disclosure provided they come within the scope of the appended claims and their equivalents.

What is claimed is:

1. A data processing system comprising:
a OneNAND flash memory which includes an internal non-volatile memory and an internal buffer memory which temporarily stores a page data derived from the internal non-volatile memory; and
a first memory controller which includes a speed-up buffer and which controls read operations of the OneNAND flash memory such that the page data stored in the OneNAND internal buffer memory is sequentially and continuously output in multiple data units from the OneNAND flash memory to an exterior device through the speed-up buffer.

2. The data processing system of claim 1, further comprising:
a working memory;
a second memory controller for controlling the working memory; and
a direct memory access (DMA) controller having a buffer,
wherein data outputted from the speed-up buffer is temporarily stored in the buffer of the DMA controller.

3. The data processing system of claim 2, wherein the data stored in the DMA controller buffer is stored in the working memory through the second memory controller.

4. The data processing system of claim 3, wherein a data transmission from the speed-up buffer to the DMA controller and a data transmission from the DMA controller buffer to the working memory are performed during a data transmission from the OneNAND internal buffer memory to the speed-up buffer.

5. The data processing system of claim 4, wherein the speed-up buffer and the DMA controller buffer include a first first-in first-out (FIFO) memory.

6. The data processing system of claim 1, further comprising a central processing unit (CPU), wherein the first memory controller further includes a register set for storing a command and address provided by the CPU.

7. The data processing system of claim 6, wherein the first memory controller is configured to control the OneNAND flash memory according to information stored in the register set such that a read operation for a next page of data is performed during a time frame when a first page of data is being transmitted through the speed-up buffer.

8. The data processing system of claim 1, wherein the first memory controller further includes an advanced high-performance bus (AHB) interface for communicating with the exterior device.

9. The data processing system of claim 6, wherein the first memory controller further includes a direct memory access (DMA) controller having a buffer, and wherein data outputted from the speed-up buffer is temporarily stored in the DMA controller buffer.

10. The data processing system of claim 9, wherein the data stored in the DMA controller buffer is provided to a working memory through a second memory controller.

11. A data processing system comprising:
a OneNAND flash memory which includes an internal non-volatile memory and an internal buffer memory which temporarily stores a page data derived from the internal non-volatile memory; and
a controlling means for controlling read operations of the OneNAND flash memory such that the page data stored in the OneNAND internal buffer memory is sequentially and continuously output in multiple data units from the OneNAND flash memory to an exterior device through the speed-up buffer.

12. The data processing system of claim 1, further comprising a direct memory access (DMA) controller having a buffer, wherein data outputted from the speed-up buffer is temporarily stored in the DMA controller buffer.

13. The data processing system of claim 4, wherein at least one of the speed-up buffer and the DMA controller buffer includes a first-in first-out (FIFO) memory.

14. A method for extracting data from a OneNAND flash memory to a RAM device, wherein the OneNAND flash memory includes an internal non-volatile memory and an internal buffer memory for temporarily storing a page of data derived from the internal non-volatile memory, the method comprising:
controlling memory operations of the OneNAND flash memory such that the page data stored in the buffer memory is sequentially outputted in multiple data units from the OneNAND flash memory to the RAM, wherein the entire page data is output at an average time period per data unit that is less that a combined time for both a read operation of a data unit from the OneNAND flash memory and a write operation of a data unit to the RAM.

15. The method for extracting data of claim 14, wherein the page data stored in the buffer memory is continuously outputted in the multiple data units from the OneNAND flash memory to the RAM.

16. The method for extracting data of claim 14, further comprising temporarily storing data units in a buffer of a direct memory access (DMA) controller.

17. The method for extracting data of claim 14, further comprising temporarily storing data units in a first-in first-out (FIFO) memory.
